(19) United States
(12) Patent Application Publication
(10) Pub. No.: US 2011/0143924 A1
(43) Pub. Date: Jun. 16, 2011

(54) PHOTOCATALYST COATING COMPOSITION

(76) Inventors: Yoshikatsu Hisata, Osaka (JP); Yukinobu Harada, Osaka (JP); Akira Kyogoku, Osaka (JP)

(21) Appl. No.: 13/054,919

(22) PCT Filed: Jul. 24, 2008
(86) PCT No.: PCT/JP2008/001978

§ 371 Date: Jan. 19, 2011

(51) Int. Cl. B01J 31/06; B01J 31/38; B01J 31/34; B01J 31/28; B01J 31/26

(52) U.S. Cl. 502/159

(57) ABSTRACT

To aim to provide a photocatalyst coating composition having a predefined photocatalytic function, which is to be formed as a coating film after being applied to a substrate and dried. The photocatalyst coating composition can improve adhesion property and abrasion resistance of the coating film. There is also provided a photocatalyst coating composition that has a shorter drying time after applied. The present invention provides a photocatalyst coating composition that is composed of a blend including: a graft copolymer of PTFE and perfluoro acid selected from the group consisting of perfluorosulfonic acid and perfluorocarbonic acid; a photocatalyst material; and at least one fluororesin selected from the group consisting of PVDF, PVF, PTFE, ETFE, PVDF-HFP, PCTFE, trifluorochloroethylene-alkyl vinyl ether copolymer, tetrafluoroethylene-alkyl vinyl ether copolymer, and trifluorochloroethylene-alkyl vinyl ether-alkyl vinyl ester copolymer.

### TECHNICAL FIELD

The present invention relates to a photocatalyst coating composition and a photocatalyst coating film coated substrate that is formed by applying the photocatalyst coating composition to a substrate.

### BACKGROUND ART

In recent years, an attention has been paid to a photocatalyst coating material (photocatalyst coating composition) that contains photocatalyst material having excellent dust-proof property and antibacterial property.

Also, there has been a desire for coating composition used for a substrate such as exterior walls of buildings, a vehicle body steel sheet, tent fabric or the like that have fine appearance and a property of resisting adherence of stains that are contained in raindrops or the like. That is, the property is resistance against stains derived from the environment.

In response to this desire, there has been a search for a way to effectively use coating compositions and surface treatment materials (hereafter collectively referred to as “photocatalyst coating composition”) that exhibit excellent dust-proof property and antibacterial property as well as high hydrophilicity and photocatalytic function. Generally, when such a photocatalyst material is blended as an ingredient of photocatalyst coating composition, a binder is blended so as to fully demonstrate photocatalytic function of the coating composition against stains derived from the environment. The binder is for dispersing a metal oxide well in the coating composition and forming a coating film layer after the coating dries.

In addition, a photocatalytic reaction causes a relatively violent redox reaction so as to degrade organic compounds that are components of stains. When an organic resin binder is used as the binder, the photocatalytic reaction also acts on the organic resin binder and the organic resin binder is degraded (so-called binder self-collapse). This deteriorates the coating composition and accordingly durability lowers.

In view of this problem, for example, as Patent Literature 1 discloses, there has been known a configuration in which a photocatalyst coating composition contains mainly a glassy inorganic binder called silica sol or silicate. The inorganic binder is used to ensure dispersion stability against a photocatalytic reaction.

Or else, as Patent Literature 2 discloses, there has been known a photocatalyst coating composition that uses a perfluorosulfonic acid/PTFE graft copolymer (H⁺) (registered trademark of E. I. du Pont de Nemours and Company, hereafter referred to simply as “Nafion”) as an organic resin binder. Nafion is a super-hydrophilic polymer that is hardly degradable with a photocatalytic reaction. When this organic resin binder is used, chemical stability in C—F bonds in molecular structure is ensured against a photocatalytic reaction. By using the C—F bonds as a molecular skeleton, a coating film with fine properties can be maintained for a long term. Furthermore, the use of an organic resin binder can shorten a drying time after applying the photocatalytic coating composition compared with the use of an inorganic binder. Accordingly, it is effective for a high-speed continuous production of color coated steel sheets, for example. In addition, a coating film formed by using an inorganic binder does not have flexibility. Therefore, when a substrate on which the coating film is coated is bended, the coating film can be cracked. Compared with this, a coating film formed by using an organic resin binder can demonstrate flexibility, and thus the coating film can be bended together with a substrate on which the coating film is coated. Accordingly, there is a great advantage that the coating film can be formed on a wide variety of substrates.

### CITATION LIST

### Patent Literature 1

Japanese Patent Application Publication No. H11-343426

### Patent Literature 2

Japanese Patent Application Publication No. 2006-233073

### SUMMARY OF INVENTION

### Technical Problem

However, even according to the photocatalyst coating composition formed by using the organic resin binder described in Patent Literature 2, sufficient capability has hardly been attained with regard to flexibility and abrasion resistance of the coating film and adhesion property between the coating film and the substrate. The flexibility and the abrasion resistance of the coating film are extremely important properties in demonstrating photocatalytic function of the coating film on a surface of the substrate for a long term. As a result, improvement of these properties has been strongly demanded.

The present invention has been achieved in view of the above problems, and a first aim thereof is to provide a photocatalyst coating composition having a predefined photocatalytic function, which is to be formed as a coating film after being applied to a substrate and dried, and can improve adhesion property to an underbody and abrasion resistance. The coating film has flexibility and degradation proof against a photocatalytic action.

In addition to the first aim, a second aim of the present invention is to provide a photocatalyst coating composition that has a shorter drying time after being applied.

### Solution to Problem

In order to solve the above problems, the present invention provides a photocatalyst coating composition that is composed of a blend including: a graft copolymer of PTFE and acid selected from the group consisting of perfluorosulfonic acid and perfluorocarbonic acid; a photocatalyst material; and at least one fluororesin selected from the group consisting of PVDF, PVF, PTFE, ETFE, PVDF-HFP, PCTFE, trifluorochloroethylene-alkyl vinyl ether copolymer, tetrafluoroethylene-alkyl vinyl ether copolymer, and trifluorochloroethylene-alkyl vinyl ether-alkyl vinyl ester copolymer.

In addition, in the case where the coating film is formed by bake coating, the fluororesin in a particle state may be included in the photocatalyst coating composition. In this case, it is possible to form a uniform film by melt-mixing components of the photocatalyst coating composition by the bake coating method.

Alternatively, in the case where coating is applied by another coating method, the fluororesin as an aqueous emulsion may be mixed with a resin binder. In this case, it is possible to obtain the photocatalyst coating composition that can be dried at room temperature after being applied.

Alternatively, the fluororesin as a liquid fluororesin may be mixed with a resin binder. In this case, an FEVE fluororesin may be used as the liquid fluororesin.

The photocatalyst material may be at least one metal oxide selected from the group consisting of TiO₂, ZnO, WO₃, SnO₂, SrTiO₃, Bi₂O₃, and Fe₂O₃.

The photocatalyst material may be porous. Since this structure can increase a surface area of a catalyst, it is possible to effectively improve catalyst function for removing stains. Also, it is possible to exhibit deodorant function by adsorptive property, with use of a concave-convex surface of a substrate.

In addition, the photocatalyst coating composition of the present invention preferably includes at least one of methanol, ethanol, and propyl alcohol, which are volatile lower alcohol. With such a structure, it is possible to form the coating film speedily by volatilizing a solvent rapidly after applying the photocatalyst coating composition.

Also, the photocatalyst coating composition of the present invention may add thereto at least one of an inorganic ultraviolet absorbing agent, an organic ultraviolet absorbing agent, and a light stabilizer.

Also, the present invention provides a photocatalyst coating film coated substrate that is formed by applying the above-mentioned photocatalyst coating composition of the present invention to a substrate.

### Advantageous Effects of Invention

The photocatalyst coating composition of the present invention is composed of a blend including a specific fluororesin, in addition to a graft copolymer of PTFE and perfluoro acid selected from the group consisting of perfluorosulfonic acid and perfluorocarbonic acid. Each of these components has, in its molecular composition, many C—F bonds that have a high binding energy. Accordingly, by containing the C—F bonds as a backbone of the coating composition, it is possible to effectively prevent self-collapse of the coating film caused by a photocatalytic reaction. It is therefore possible to maintain the coating film having a high function for a long term. Also, by using the above specific fluororesins, the coating film formed by applying and drying the photocatalytic coating composition can demonstrate flexibility and abrasion resistance, with use of the above characteristics of the fluororesins. Furthermore, sulfonic acid groups in perfluorosulfonic acid demonstrate super-hydrophilicity on a surface of the coating film. As a result, an effect of removing stains is demonstrated by forming a water film on the surface of the coating film.

In addition, properties of the above specific fluororesins can also improve adhesion property to an underbody that consists of metals, inorganic compounds or the like other than organic compounds. At the same time, it is possible to improve durability of the coating film after formed.

Furthermore, with use of the photocatalyst coating composition including a particulate fluororesin that is dispersed in Nafion, both of adhesion property and abrasion resistance of the coating film can be improved by bake coating of the photocatalyst coating composition on a predetermined underbody.

### BRIEF DESCRIPTION OF DRAWINGS

FIG. 1 diagrammatically shows a cross section of a coating film and a substrate according to an example.

### REFERENCE SIGNS LIST

10 coating film coated substrate
11 substrate
12 coating film
13 photocatalyst particles
14 binder layer

### DESCRIPTION OF EMBODIMENT

An embodiment and examples of the present invention are described below. However, it will be apparent that the present invention is not limited to these configurations and various changes may be made without departing from the technical scope of the present invention.

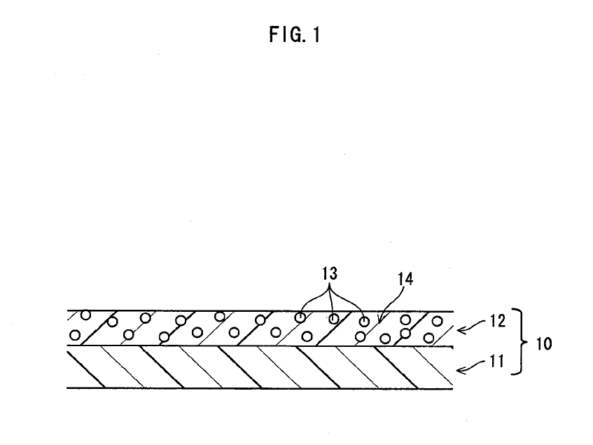

FIG. 1 is a partial cross-sectional view of a coating film coated substrate. A coating film 12 is formed by applying and drying a photocatalyst coating material composed of a photocatalyst coating composition of the present invention (hereafter referred to simply as “photocatalyst coating composition”) on a substrate. In FIG. 1, reference numbers 10, 11 and 12 show a coating film coated substrate, a substrate and a coating film, respectively.

The coating film 12 is formed by applying and drying the photocatalyst coating composition according to the present embodiment. The photocatalyst coating composition is composed of an organic resin binder as a main component, a photocatalyst material, a predetermined fluororesin and an aqueous solvent that contains a lower alcohol with the weight percentage of 1-30 pts.wt., 0.1-20 pts.wt., 0.1-10 pts.wt. and 5-80 pts.wt., respectively. The lower alcohol is at least one of methanol, ethanol, 1-propyl alcohol, and isopropyl alcohol. The coating film 12 shown in FIG. 1 is formed by drying and removing a solvent of the photocatalyst coating composition by volatilization. The coating film 12 has a configuration in which photocatalyst particles (TiO₂) 13 are dispersed in the binder layer 14 (about 5 μm thick) that has the organic resin binder and the fluororesin as a backbone.

The organic resin binder is Nafion, that is, a graft copolymer of PTFE and perfluorosulfonic acid that has graft-polymerized Sulfonic acid (SO₃H). Its chemical structure is shown by a following chemical formula (Chemical Formula 1).

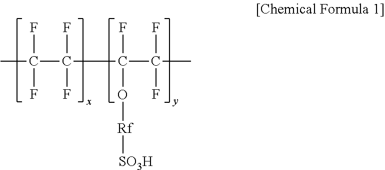

As this chemical formula (Chemical Formula 1) shows, Nafion is a graft polymer composed of repeating units of polymeric tetrafluoroethylene that has a side chain of sulfonic acid (in other words, PTFE having graft-polymerized sulfonic acid groups). Nafion does not have C—H bonds, but has C—F bonds that exhibit high stability. For this reason, Nafion has excellent chemical stability that makes C—F backbones hard to be cut by unnecessary chemical reactions.

Specifically, a C—F bond has a bond energy (approximately 500 kJ/mol) that is sufficiently larger than each bond energy of a C—H bond (415 kJ/mol) and a C—C bond (347 kJ/mol). Accordingly, Nafion can form molecular chains with high chemical stability. Because of this chemical stability, Nafion can stably exist for a long term in the coating film 12 without undergoing degradation reactions by a photocatalyst. Furthermore, crystallinity of Nafion is so high that extremely precise crystal structure can be formed. Nafion even exhibits excellent chemical resistance, weather resistance, and high stability against electrochemical reactions. In addition to this, Nafion exhibits properties such as low surface tension and low coefficient of friction. It is thought that since an F atom has a small atomic radius and low polarizability and accordingly the intermolecular cohesive force is low, the C—F bonds have excellent flexibility (see “Plastic and Functional Polymer Dictionary”, pp. 306 (Industrial Research Center of Japan, 2004)).

Nafion is generally used as a solid electrolyte for a solid polymer fuel cell (SPFC). Nafion is an organic polymer resin that exhibits high stability (such as proton conductivity and thermal stability) against electrochemical reactions (water synthesis reactions) associated with power generation. Inventors of the present invention have conducted experiments to reveal that these electrochemical properties exhibit extremely high stability against a photocatalytic reaction that is a kind of the electrochemical reactions that are similar to a power generation reaction.

Here, a copolymer of PTFE and perfluorosulfonic acid is used. However, the present invention is not limited to this and a copolymer of PTFE and perfluorocarbonic acid may be used. A blend of these copolymers may also be used.

A predetermined fluororesin contained in the coating film 12 is at least one fluororesin selected from the group consisting of PVDF, PVF, PTFE, ETFE, PVDF-HFP, PCTFE, trifluorochloroethylene-alkyl vinyl ether copolymer, tetrafluoroethylene-alkyl vinyl ether copolymer, trifluorochloroethylene-alkyl vinyl ester copolymer and trifluorochloroethylene-alkyl vinyl ether-alkyl vinyl ester copolymer. By adding the predetermined fluororesin, the excellent flexibility and abrasion resistance are given to the coating film 12.

Such a fluororesin also has a molecular skeleton that is composed of many C—F bonds as Nafion has. Accordingly, the fluororesin has chemical stability that makes C—F bonds hard to be cut by a catalytic reaction. By forming the binder layer 14 with the fluororesin and Nafion, it is possible to exhibit an effect of structurally stabilizing the coating film 12.

In addition, a fluororesin as a particulate material may be used. It is possible to disperse such a fluororesin in the photocatalyst coating composition, and apply the photocatalyst coating composition on a target surface by bake coating. This bake coating method can form the coating film 12 that is integrated with Nafion on a surface of the substrate 11, as melting a particulate fluororesin by heat. Also, this bake coating method enables the coating film 12 to well contain components of the fluororesin, and to improve adhesion property between the coating film 12 and the substrate 11 and abrasion resistance to the exterior with use of excellent properties of the fluororesin. In case where a Kynar fluororesin is used, the baking temperature is preferably 220-240 degrees Celsius. In the case where a trifluorochloroethylene-alkyl vinyl ether copolymer is used, the baked temperature is preferably 160-180 degrees Celsius.

Apart from the above, a fluororesin that has been adjusted as an aqueous emulsion may be blended. The photocatalyst coating composition using such an aqueous emulsion can be dried at least at room temperature, and does not need an additional heating process for drying. As a result, work efficiency in applying the photocatalytic coating composition can be greatly improved, and an effect of coating a large area at a low cost can be expected.

Alternatively, apart from the above, a liquid fluororesin may be used. Examples of the liquid fluororesin include a fluoroethylene-vinyl ether alternating copolymer (hereafter referred to as “FEVE fluororesin”) and a polyvinylidene fluoride-tetrafluoroethylene-hexafluoropropylene copolymer (hereafter referred to as “PVDF fluororesin”). The FEVE fluororesin is exemplified by “LUMIFLON” (registered trademark of ASAHI GLASS CO., LTD.), “CEFRAL COAT” (registered trademark of Central Glass Co., Ltd.), “FLUONATE” (registered trademark of DIC Corporation) or the like, and the PVDF fluororesin is exemplified by “Kynar ADS” (registered trademark of Arkema, Inc.) or the like. The photocatalyst coating composition containing these liquid fluororesins can be dried at room temperature. In the case where cross-linking groups such as hydroxyl groups, carbonyl groups or the like are included, the coating film with excellent bonding property can be formed in combination with cross-linking agent such as blocked-isocyanate or the like by bake coating.

The photocatalyst particles 13 are an exemplification of the photocatalyst material. Here, primary particles are composed of a metal oxide whose average particle diameter is 7 nm. The primary particles coagulate to be secondary particles and tertiary particles, each average particle diameter of which is approximately 200-300 nm, and disperse in the coating film 12.

FIG. 1 diagrammatically illustrates the photocatalyst particles 13 as the primary particles for purposes of explanation.

Examples of the metal oxide include at least one of titanium oxide (TiO₂), zinc oxide (ZnO), tungsten oxide (WO₃), titanium oxide (SnO₂), strontium titanate (SrTiO₃), bismuth oxide (Bi₂O₃) and iron oxide (Fe₂O₃). Among them, the titanium oxide is preferable since it especially has stable photocatalytic function and is easily available. Some titanium oxide available in market is in a fine particle state, and such titanium oxide is convenient to use as the photocatalyst particles 13 of the present invention. The photocatalyst coating composition of the present invention can be formed by blending and agitating a predetermined amount of the titanium oxide with an appropriate resin binder into an organic solvent, water or the like.

Thickness of the coating film 12 is exemplified as approximately 5 μm. It is far thicker than traditional coating films (approximately 0.1 μm thick) that use an inorganic binder. As a result, it is possible to form the solid coating film 12.

It is noted that copolymers of PTFE and perfluoro acid selected from the group consisting of perfluorosulfonic acid and perfluorocarbonic acid, including Nafion, are soluble only in water, a few kinds of alcohols (ethanol, for example) or the like. Accordingly, the coating methods of the photocatalytst coating composition are the following:

A. A method for coating, by bake coating, a substrate with the photocatalyst coating composition produced by blending and dispersing the photocatalyst material and the particulate fluororesin in Nafion;

B. A method for coating a target surface with the photocatalyst coating composition produced by blending the photocatalyst material and Nafion and adding the fluororesin as an aqueous emulsion to a blend; and

C. A method for coating a target surface with the photocatalyst coating composition produced by blending Nafion and the liquid fluororesin that is compatible with alcohols and dispersing the photocatalyst material in the photocatalyst coating composition.

Water and alcohol are added to the blend at a ratio of water to alcohol of 5-80 pts.wt. to 5-80 pts.wt. In the case of the bake coating method A, it is preferable to set 5-20 pts.wt. of water and 50-80 pts.wt. of alcohol. In the case of the coating method B, it is preferable to set 60-80 pts.wt. of water and 5-20 pts.wt. of alcohol.

According to the bake coating method A, it is possible to produce the coating film highly integrated with Nafion by melting the fluororesin by heat at the bake coating. Accordingly, even if a coating area is large, such a coating method has an advantage of demonstrating uniform characteristics of the coating film on the whole coating film 12. In addition, since the coating material melted at the bake coating conforms closely to a concave-convex surface of the substrate 11, it is possible to achieve excellent adhesion property of the coating film 12 to the substrate 11.

According to the coating method B, it is possible to apply and dry the coating composition at room temperature (specifically, in the range of 5-35 degrees Celsius according to JIS Z8703), by using an aqueous emulsion.

According to the coating method C, the liquid fluororesin includes cross-linking groups such as hydroxyl groups, carbonyl groups or the like. By blending isocyanate with the coating composition and drying the coating composition at room temperature, or blending blocked isocyanate and performing bake coating, it is possible to form a coating film having excellent bonding property.

In addition, by blending the photocatalyst coating composition with a predetermined lower alcohol such as ethanol, isopropyl alcohol or the like, it is possible to greatly shorten a drying time after applying the photocatalyst coating composition. Because of such a shorter drying time, it is therefore preferable to apply such a coating composition to materials manufactured by continuous production. For example, the coating composition can be applied to a production line of color coated steel sheets that is manufactured by continuous production in which the coating film is formed by high-speed bake coating.

For example, in the case where the coating film is formed to be 1-2 μm thick, the drying time is less than 1 minute under 80 degrees Celsius atmosphere. Such a drying time is very short.

In addition, a conventional photocatalyst coating composition that includes an inorganic binder has a disadvantage that a drying time is affected by environmental moisture and if moisture is scarce, it is impossible to promote a condensation reaction by hydrolysis. In the present invention, however, the environmental moisture is not a factor that limits the speed of drying of the coating film, and it is possible to dry the coating film 12 stably and speedily.

According to the photocatalyst coating composition that has the composition described above, the binder layer 14 is included in the coating film 12 that is formed by applying and drying the photocatalyst coating composition. Outside of the surface of the binder layer 14, sulfonic acid groups (SO₃H groups) included in Nafion are exposed. When water attaches to the surface, the sulfonic acid groups exhibit superhydrophilic property and a flat water film is formed on the whole surface of the coating film 12. Since the binder layer 14 included in the coating film 12 has Nafion, which is an excellent proton-conductive material, proton conductivity is increased in the binder layer 14. As a result, superhydrophilic property provided by the sulfonic acid groups is well maintained on the surface of the coating film 12 and accordingly the thin water film is easily formed.

Therefore, in such a condition, if hydrophobic stains (such as smoke particles contained in raindrops) adhere to the coating film 12 from the outside, the water film enters an interfacial surface between the coating film 12 and the stains, and as a result, the stains are floated and removed. In addition, even if in the case water such as raindrops or the like is attached after stains have adhered to the coating film, a water film is formed by above process and the stains are floated and removed. As a result, an excellent cleaning effect can be demonstrated on the surface of the coating film 12.

On the other hand, when light is irradiated from outside, the photocatalyst particles 13 dispersed in the coating film 12 are excited by receiving radiation energy. At a vicinity of the surface of the coating film 12 exposed to the air, the oxygen in the air takes energy from the photocatalyst, and such excitement changes oxygen in the air into active oxygen. The active oxygen affects hydrophobic stains so as to degrade the stains, impair adhesion of the stains to the coating film 12 and easily remove the stains on the surface or at a vicinity of the coating film 12. As a result, when raindrops or the like attaches to the coating film, the stains are easily washed away.

In addition, since the coating film 12 is formed from the photocatalyst coating composition that includes an organic resin binder to the composition, the coating film 12 demonstrates flexibility and expansibility. Especially, a certain amount of flexibility is demonstrated by using Nafion. Accordingly, in the case where the substrate 11 is made of a building material such as a soft vinyl chloride material, a polycarbonate board, a sealing material or the like, even when the substrate is distorted after the coating film 12 is formed, the coating film 12 flexibly bends in accordance with distortion of the substrate 11. As a result, the coating film 12 does not peel from the substrate 11. In addition to this, it is possible to finely form the coating film 12 on a steel sheet on which a bending process is performed after the coating film 12 is formed, or on tent fabric that is repeatedly folded and assembled. Thus, according to the present invention, a wider variety of a substrate, a larger coated area, and a wider applied environment will be available, compared with the case of using an inorganic binder that is undistortable. It is therefore possible to prevent properties of the coating film 12 from being affected by properties of the substrate, compared with conventional arts.

In addition, it is obviously possible to apply the photocatalyst coating composition of the present invention on objects that lack flexibility or expansibility (e.g., glass boards, bare concrete walls, tiles, stones, and aluminum panels). By blending the fluororesin in the photocatalyst coating composition, adhesion property to a metal or an inorganic underbody is improved and the solid coating film 12 can be formed. Especially in the case where an FEVE fluororesin is used, with use of hydroxyl groups in its molecules, the coating film can demonstrate strong adhesion property to the underbody by binding the underbody and the coating film 12 by intermolecular binding or the like. In the case where a PVDF fluororesin is used, the coating composition can be strongly bonded to the concave-convex surface of the substrate due to physical bonding, when the coating composition is applied and melted by thermal melting. It is therefore possible to form a coating film that is tightly bonded to the substrate.

In addition, by using the organic resin binder, it is possible to freely set thickness of the coating film to some extent, compared with the case of using an inorganic resin binder. Specifically, with use of inorganic binder, it is only possible to form a film of about 0.1 μm thick. However, according to the present invention, it is possible to adjust thickness of the coating film from some of μm to dozens of μm. Accordingly, by designing a thick film, it is possible to beforehand provide a thickness that is enough to take effective measure against temporal abrasion of the coating film.

Furthermore, as well as the effects mentioned above, the coating film 12 demonstrates excellent durability. That is, a perfluorosulfonic acid that has many C—F bonds is used as an organic resin binder that is a main skeleton of the coating film 12. As a result, for example, even when irradiation of ultraviolet rays for a long term excites photocatalyst in the coating film and a photocatalytic reaction occurs on the surface of the coating film 12, the skeleton of the C—F bonds in the binder layer 14 are not easily degraded by the photocatalytic reaction.

For this reason, according to the present invention, it is possible to successfully maintain for a long term the fine coating film 12 without self-collapse caused by photocatalytic reactions. In addition, it is possible to add photocatalyst to the photocatalyst coating composition to the limit of photocatalyst that can be included in photocatalyst coating compositions, and to freely set catalyst concentration free from any fear of the self-collapse of the coating film 12.

As a main characteristic of the present invention, the photocatalyst coating composition contains a predetermined fluororesin in addition to Nafion. For this reason, excellent abrasion resistance attributed to such a fluororesin is given to the coating film 12 formed by applying the photocatalyst coating composition. That is, by adding the fluororesin, coefficient of friction of the coating film 12 becomes greatly low, and the coefficient of friction can be extremely reduced in the case where the coating film 12 contacts, slides and so on with an object from outside. As a result, strength of the coating film 12 is greatly increased and abrasion resistance is spectacularly improved. Therefore, some contacts with outside do not greatly damage nor chip the coating film 12.

In addition, it is also possible to give flexibility and expansibility to the coating film to some extent by increasing a quantity of Nafion. However, in consideration of production cost or full use of properties of the fluororesin, it is advantageous to use the above-mentioned predetermined fluororesin.

In addition, since the photocatalyst coating composition contains plentiful predetermined fluororesin, adhesion property to a target coating area is improved by utilizing characteristics of the fluororesins. Thus, the coating film 12 is chemically less abradable from the surface of the substrate 11.

Furthermore, in order to further improve adhesion property of the coating film, a bake coating method such as the above-mentioned coating method A is preferable. Such a method allows melted coating components to enter concavity and convexity of the surface of the substrate so as to be firmly bonded to the concave-convex surface. As a result, even if the substrate is made of a metal or an inorganic material, excellent adhesion property can be expected.

In addition, by adding the photocatalyst particles 13 to the coating film 12, it is also possible to increase a surface area of the coating film 12 so as to demonstrate deodorant function and antibacterial function. With use of such functions, the photocatalyst coating composition has the advantage of forming the coating film 12 having excellent properties that meet demand characteristics in a usage environment that requires sanitary properties such as hospital facilities.

In order to fully demonstrate deodorant function and antibacterial function, the coating film 12 in itself needs to include sufficient gas absorption capability. For this purpose, an absorption surface area of the coating film 12 has to be increased. Specifically, for example, materials that have a large specific surface area have to be adopted for the photocatalyst particles 13, and especially a material having the specific surface area of 100 m²/g or greater is preferable. Such a material is exemplified by a porous titanium oxide such as “ST-01” and “ST-31” (manufactured by Ishihara Sangyo Kaisha, Ltd.), “AMT-100” (manufactured by Tayca Corporation) or the like, or a porous body such as silica, zeolite or the like, which supports titanium oxide.

By including a large number of the porous photocatalyst particles 13 in the coating film 12, the surface itself of the coating film 12 also becomes porous. Accordingly, the surface area of the coating film 12 significantly increases, and adsorptive property is demonstrated on the whole coating film 12. As a result, excellent deodorant function or antibacterial function is demonstrated to gas, liquid or a various type of microorganisms around the coating film 12.

### (Experiments for Performance Confirmation)

Here, examples of the photocatalyst coating composition of the present invention are described. The present invention is of course not limited to compositions of each example below.

### (Experiment 1)

Experiments for adhesion property and abrasion resistance were conducted, regarding the case where a substrate was made from stone material. A fluororesin used in the present invention was in the form of an aqueous emulsion.

### Example A1

35 pts.wt. of 20 percent solution of “Nafion DE 2021” manufactured by E. I. du Pont de Nemours and Company (prepared by Wako Pure Chemical Industries, Ltd.), 3 pts.wt. of “ST-01” (manufactured by Ishihara Sangyo Kaisha, Ltd.: absorption surface area of 300 m²/g), which is titanium oxide of porous photocatalyst particles, and 42 pts.wt. of isopropyl alcohol were blended. The blend was vigorously agitated by using a paint shaker. Additionally, 20 pts.wt. of “LUMIFLON FE 4400” (manufactured by ASAHI GLASS CO., LTD.), which is an aqueous emulsion of trifluorochloroethylene-alkyl vinyl ether copolymer, was added to the blend, and the blend was agitated well. A photocatalyst coating composition that is an example of the present invention (Example A1) was formed by this process.

### Comparative Example B1

Only “LUMIFLON FE 4400” (manufactured by ASAHI GLASS CO., LTD.) was omitted from the composition of Example A1. That is, a photocatalyst coating composition of a comparative example (Comparative Example B1) was formed by blending only 20 percent solution of “Nafion DE 2021” manufactured by E. I. du Pont de Nemours and Company (prepared by Wako Pure Chemical Industries, Ltd.), “ST-01” (manufactured by Ishihara Sangyo Kaisha, Ltd.: absorption surface area of 300 m²/g), which is titanium oxide or porous photocatalyst particles, and isopropyl alcohol.

Next, the Example A1 and the Comparative Example B1 were applied on a surface of the substrate made of the stone material (granite) such that dried coating amount of each of the photocatalytic coating compositions became 1 g/m². After that, coating films were formed by drying the photocatalytic coating compositions for 24 hours at room temperature. On these coating films, experiments for adhesion property and abrasion resistance were conducted.

The experiment for adhesion property was conducted by a grid-tape peel test according to JIS K5400.

The experiment for abrasion resistance was conducted by a simplified coin-scratch test. In this test, the coating film was scratched with an edge of a 10-yen coin.

The results are shown in Table 1.

TABLE 1

| | | Comparative |
|---|---|---|
| | Example A1 | Example B1 |
| Evaluation of Adhesion | 100/100 (Excellent) | 0/100 (Bad) |
| property; Number of | | |
| Peel-Off/Overall Number | | |
| Evaluation of Abrasion | Only Slight Flaws | Peel-off Occurred |
| Resistance; Visual Evaluation | Occurred | |

Obviously from the Table 1, the Example A1 of the present invention showed that no peeling was found and the Example A1 had excellent adhesion property. Also, the Example A1 showed that there were slight flaws but no abrasion after the coin-scratch test and the Example A1 had excellent abrasion resistance.

On the other hand, the Comparative Example B1 in which a fluororesin except for Nafion was not blended showed that in the experiment for adhesion property all of the coating film peeled and adhesion failure obviously occurred. Also, the experiment for abrasion resistance showed that the coating film peeled.

The result revealed that the coating film of the Example A1 had far more excellent adhesion property and abrasion resistance than that of the Comparative Example B1, at least on the substrate made of the stone material.

### (Experiment 2)

Next, regarding the case where a substrate is made of tent fabric composed of a fluororesin (PVDF), experiments for adhesion property and abrasion resistance of a coating film were conducted. The fluororesin in a particle state was used in the present experiment.

### Example A2

35 pts.wt. of 20 percent solution of “Nafion DE 2021” manufactured by E. I. du Pont de Nemours and Company (prepared by Wako Pure Chemical Industries, Ltd.), 3 pts.wt. of “ST-01” (manufactured by Ishihara Sangyo Kaisha, Ltd.: absorption surface area of 300 m²/g), which is porous photocatalyst particle titanium oxide, and 42 pts.wt. of isopropyl alcohol were blended. The blend was vigorously agitated by using a paint shaker. Additionally, 20 pts.wt. of “KF polymer C# 1000” (manufactured by Kureha Corporation) as PVDF powder was added to the blend, and the blend was agitated well. A photocatalyst coating composition that is an example of the present invention (Example A2) was formed by this process.

### Comparative Example B2

Only “KF polymer C# 1000” (manufactured by Kureha Corporation) was omitted from the composition of Example A2. That is, a photocatalyst coating composition of a comparative example (Comparative Example B2) was formed by blending only 20 percent solution of “Nafion DE 2021” manufactured by E. I. du Pont de Nemours and Company (prepared by Wako Pure Chemical Industries, Ltd.), “ST-01” (manufactured by Ishihara Sangyo Kaisha, Ltd.: absorption surface area of 300 m²/g), which is titanium oxide of porous photocatalyst, and isopropyl alcohol.

The Example A2 and the Comparative Example B2 were applied on the surface of the substrate made of the tent fabric such that dried coating amount of each of the photocatalytic coating compositions became 1 g/m². After that, coating films were formed by drying the photocatalytic coating compositions for 30 minutes at 230 degrees Celsius. On these coating films, the experiments for adhesion property and abrasion resistance were conducted in the same way as the Experiment 1.

The results are shown in Table 2.

TABLE 2

| | | Comparative |
|---|---|---|
| | Example A2 | Example B2 |
| Evaluation of Adhesion | 100/100 (Excellent) | 60/100 (Above Average) |
| property; Number of | | |
| Peel-Off/Overall Number | | |
| Evaluation of Abrasion | No Flaws Occurred | Peel-off Occurred |
| Resistance | | |

Obviously from the Table 2, the coating film of the Example A2 showed that no peeling occurred in the experiment for adhesion property. Furthermore, in the experiment for abrasion resistance, noticeable flaws were not found.

On the other hand, the coating film formed from the Comparative Example B2 that did not contain a fluororesin except for Nafion showed that 60 percent of the coating film remained without peeling in the experiment for adhesion property. From such a result, it can be said that adhesion property of the coating film is from average but there is need for a further improvement. In addition, the Comparative Example B2 showed that abrasions occurred in the coin-scratch test. As a result, abrasion resistance of the coating film is far from excellent.

The above result shows that, according to the Example A2 of the present invention in which the fluororesin was blended in Nafion, the Example A2 was significantly improved in each of adhesion property and abrasion resistance to a tent fabric, compared with the Comparative Example B2. Especially, the Example 2 showed that the use of the photocatalyst coating composition containing a known fluororesin in addition to Nafion and photocatalyst improved adhesion property to a metal or an inorganic underbody, and as a result, abrasion resistance of the coating film is improved.

### (Experiment 3)

Next, an experiment for adhesion property and abrasion resistance of a coating film was conducted in the case where a substrate is made of a steel sheet coated by an FEVE fluororesin. The fluororesin used in the present invention is liquid fluororesin.

### Example A3

25 pts.wt. of 20 percent solution of “Nafion DE 2021” manufactured by E. I. du Pont de Nemours and Company (prepared by Wako Pure Chemical Industries, Ltd.), 3 pts.wt. of “ST-01” (manufactured by Ishihara Sangyo Kaisha, Ltd.: an absorption surface area of 300 m²/g), which is porous photocatalyst particle titanium oxide, 26 pts.wt. of isopropyl alcohol and 26 pts.wt. of methyl ethyl ketone were blended. The blend was vigorously agitated by using a paint shaker. Additionally, 20 pts.wt. of “LUMIFLON LF 600” (manufactured by ASAHI GLASS CO., LTD.), which is liquid fluororesin, was added to the blend, and the blend was agitated well. A photocatalyst coating composition that is an example of the present invention (Example A3) was formed by this process.

### Comparative Example B3

Only “LUMIFLON LF 600” (manufactured by ASAHI GLASS CO., LTD.) was omitted from the composition of Example A3. That is, a photocatalyst coating composition of a comparative example (Comparative Example B3) was formed by blending only 20 percent solution of “Nafion DE 2021” manufactured by E. I. du Pont de Nemours and Company (prepared by Wako Pure Chemical Industries, Ltd.), “ST-01” (manufactured by Ishihara Sangyo Kaisha, Ltd.: absorption surface area of 300 m²/g), which is porous photocatalyst particle titanium oxide, isopropyl alcohol and methyl ethyl ketone.

The Example A3 and the Comparative Example B3 were applied on a surface of the substrate made of the steel sheet coated by the FEVE fluororesin such that dried coating amount of each of the photocatalytic coating compositions became 2 g/m². After that, the coating film was formed by applying and drying the coating composition for 20 minutes at 170 degrees Celsius. The experiments for adhesion property and abrasion resistance were conducted on the coating film in the same way as the Experiment 1.

In addition, surface hardness was measured by a scratch hardness test (a pencil method) according to JIS K 5600.

The results are shown in Table 3.

TABLE 3

| | | Comparative |
|---|---|---|
| | Example A3 | Example B3 |
| Evaluation of Adhesion | 100/100 (Excellent) | 50/100 (Below Average) |
| property; Number of | | |
| Peel-Off/Overall Number | | |
| Evaluation of Abrasion | No Flaws Occurred | Peel-Off Occurred |
| Resistance | | |
| Evaluation of Surface | 2H | F |
| Hardness | | |

Obviously from the Table 3, the coating film of the Example A3 revealed that no peeling occurred in the experiment for adhesion property. Furthermore, in the experiment for abrasion resistance, noticeable flaws were not found. In addition, surface hardness of the coating film improved, compared with the Comparative Example B3.

On the other hand, the Comparative Example B3 that did not contain a fluororesin except for Nafion showed that 50 percent of the coating film peeled in the experiment for adhesion property. From such a result, it can be said that adhesion property of the coating film is rather inferior and there is need for a further improvement. In addition, the Comparative Example B3 showed that abrasions occurred in the coin-scratch test. As a result, abrasion resistance of the coating film is far from excellent.

The above result shows that, according to the Example A3 of the present invention in which the liquid fluororesin was blended in Nafion, the Example A3 was significantly improved in each of the adhesion property and the abrasion resistance to the coated steel sheet, compared with the Comparative Example B3. Especially, the Experiment 3 showed that the use of the photocatalyst coating composition containing a known liquid fluororesin in addition to Nafion and photocatalyst improved surface hardness of the coating film.

Also, comparing the Examples A1, A2 and A3, the fluororesin in any state, that is, an aqueous emulsion, particles or liquid, eventually provided the coating film with a fine property. Accordingly, the fluororesin in any state may be added when the present invention is embodied. In order to gain the coating film speedily, it is preferable to use the particulate fluororesin or the liquid fluororesin and apply the coating composition by heat, like the Example A1. On the other hand, even in the case where a heating process cannot be conducted because of circumstances such as a coated area, properties of the substrate or the like, the coating film can be provided in about 24 hours with use of the coating composition to which the fluororesin as an aqueous emulsion or the liquid fluororesin has been added.

Each experiment described above showed superiority of the present invention to the traditional arts.

### (Others)

The resin binder included in the photocatalyst coating composition of the present invention employs the resin that is not degraded by photocatalyst and accordingly provides flexibility to the coating film. However, in a photocatalytic reaction, reaction energy might cut C—H bonds, as described above. For this reason, it is preferable to use the organic resin binder that includes C—H bonds as few as possible and includes a molecular skeleton composed of C—F bonds or the like, which include a high binding energy. In this respect, Nafion, which includes perfluorosulfonic acid and PTFE, is preferable.

To the photocatalyst coating composition, it may be possible to further add another chemical compound selected from inorganic ultraviolet absorbing agents such as zinc oxide, titanium oxide, cerium oxide or the like, organic ultraviolet absorbing agents such as benzotriazole, salicylic acid, benzophenone, or light stabilizers such as hindered amine. This provides the coating film with ultraviolet prevention function. However, depending on an additive material or additive amount, it should be noted that transparency of the coating film might lower.

Furthermore, it may be possible to form a primer between the coating film and the substrate for improving adhesion property of the coating film. Also, it is possible to form an underbody on the surface of the substrate. The primer may be formed from an FEVE (fluoroethylene-vinyl ether copolymer) resin, for example. When a target coating surface is coated with an underbody, it is possible to extend a service life of the underbody by using a fluororesin for the primer.

### INDUSTRIAL APPLICABILITY

The photocatalyst coating composition of the present invention can be widely used for a building material such as concrete, sealing parts, tiles, stones, aluminum panels, glasses and polycarbonate boards, or for a coating material for protecting against stains derived from the environment and gaining a cleaning effect.

1. A photocatalyst coating composition that is composed of a blend including:
a graft copolymer of PTFE and acid selected from the group consisting of perfluorosulfonic acid and perfluorocarbonic acid;
a photocatalyst material; and
at least one fluororesin selected from the group consisting of PVDF, PVF, PTFE, ETFE, PVDF-HFP, PCTFE, trifluorochloroethylene-alkyl vinyl ether copolymer, tetrafluoroethylene-alkyl vinyl ether copolymer, and trifluorochloroethylene-alkyl vinyl ether-alkyl vinyl ester copolymer.

2. The photocatalyst coating composition of claim 1, wherein
the fluororesin is in a particle state.

3. The photocatalyst coating composition of claim 1, wherein
the fluororesin as an aqueous emulsion is mixed with a resin binder.

4. The photocatalyst coating composition of claim 1, wherein
the fluororesin as a liquid fluororesin is mixed with a resin binder.

5. The photocatalyst coating composition of claim 4, wherein
the liquid fluororesin is selected from the group consisting of an FEVE fluororesin and a PVDF resin.

6. The photocatalyst coating composition of claim 1, wherein
the photocatalyst material is at least one metal oxide selected from the group consisting of TiO₂, ZnO, WO₃, SnO₂, SrTiO₃, Bi₂O₃, and Fe₂O₃.

7. The photocatalyst coating composition of claim 1, wherein
the photocatalyst material is porous.

8. The photocatalyst coating composition of claim 1, wherein
the blend further includes at least one of methanol, ethanol, and propyl alcohol.

9. The photocatalyst coating composition of claim 1 having added thereto
at least one of an inorganic ultraviolet absorbing agent, an organic ultraviolet absorbing agent, and a light stabilizer.

10. A photocatalyst coating film coated substrate that is formed by applying the photocatalyst coating composition of claim 1 to a substrate.
